(19) United States
(12) Patent Application Publication
(10) Pub. No.: US 2016/0196523 A1
(43) Pub. Date: Jul. 7, 2016

(54) GOAL MANAGEMENT SYSTEM

(71) Applicant: Alliance Enterprises Inc., Lacey, WA (US)

(72) Inventor: Chris M. Pieper, Gig Harbor, WA (US)

(21) Appl. No.: 14/987,612

(22) Filed: Jan. 4, 2016

Related U.S. Application Data
(60) Provisional application No. 62/099,841, filed on Jan. 5, 2015.

(51) Int. Cl. G06Q 10/06

(52) U.S. Cl. CPC G06Q 10/06393

(57) ABSTRACT

Embodiments illustrate and describe a goal management system. A large organization is permitted to define perspectives from which the organization will be viewed by its members. Team leaders, with cooperation of the members, form goals and objectives having specific measurable criteria that are in line with the perspectives and high level goals set out by the organizations executive team. As members of the organization work to accomplish the goals, points are awarded and accolades are given thereby motivating each team member to work faithfully toward the accomplishment of the objectives.

### BACKGROUND

1. Technical Field

The present disclosure generally relates to business management. More particularly, but not exclusively, the present disclosure relates to a competitive goal management system administered via one or more computing devices.

2. Description of the Related Art

Several business management techniques are known. One technique is conventionally called Management by Objectives (MBO). Credit for this technique is often given to Peter Drucker.

In organizations that follow the MBO approach, managers and employees work together to define targeted objectives to be accomplished within definite time periods. The organization's objectives are generally set out at the top, and lower levels within the organization create objectives that work to satisfy the top-level objectives. Progressively lower levels create objectives that are aligned with both the objectives immediately above and with the top-level objectives of the organization.

The MBO approach forces an organization to plan for its future. Individuals throughout the organization look forward and work together to set objectives that cooperate in a common direction. This planning allows the organization to be proactive and disciplined. Rather than merely reacting to roadblocks and hurdles that arise, the advanced planning allows the organization to create contingency plans, remediation programs, and the like in preparation for challenges that will undoubtedly arise.

One advantage of the MBO technique is that it provides an organization with an opportunity to improve efficiency and performance. Since the objectives are set with input and agreement of both managers and subordinates, the work necessary to achieve the objectives is approached with an enhanced enthusiasm and purpose. Since the higher-level objectives are visible to all of the members of the organization, the members perform better and remain committed to the work necessary to meet the objectives.

Another technique, related to MBO, is conventionally known as Objectives and Key Results (OKR). The president of INTEL, Andy Grove, is often credited with implementing the OKR technique in the 1970's, and the technique is now reportedly used in many large and small companies.

OKR is a technique for drafting, setting, and communicating specific objectives and measurable results within the organization. Like the MBO technique, the OKR technique involves giving everyone in the organization visibility into high-level, mid-level, and low-level objectives so that each individual and team knows and works in the same direction as others in the organization.

OKR's include a list of objectives, and tied to the objectives are three or four expressly listed and measurable results. The measurable results typically include some type of a scoring mechanism whereby progress toward the result is measured. Since the OKR's are made visible to the organization, members at all levels are aware of the objectives and the progress being made toward the achievement of the objectives. The crafting and visibility of the key results provides further motivation to each team member to try harder to achieve their own OKR's.

Yet one more technique is called Balanced Scorecarding (BSC). Balanced Scorecarding builds on the previously described Management by Objective (MBO), and Objectives and Key Results (OKR) techniques. In addition to setting visible objectives and specifically defined results, the BSC technique also provides a link between current actions and future outcomes.

The MBO and OKR techniques typically tie the organizational objectives to financial outcomes. The BSC technique adds three additional perspectives: a Customer perspective, an Internal Business Process perspective, and a Learning and Growth perspective. These additional perspectives permit an organization to track the achievement of its financial objectives while concurrently monitoring progress toward other intangible assets that are necessary for continued success.

In the Balanced Scorecarding approach, objectives are set in a team structure along with the results by which the objective will be measured. As they are created, however, the objectives are mapped to one or more of the four perspectives, and various ones of the objectives are linked to each other. In this way, stakeholders throughout the organization can see purpose behind each objective and how the objectives contribute to both short-term and long-term success. The stakeholders have visibility into a financial purpose of the organization, which is necessary for survival. The stakeholders also have visibility into the interactions between the organization and its internal and external customers (i.e., Customer perspective), how tasks are accomplished within the organization (i.e., Internal Business Process perspective), and how individuals within the organization are affected, valued, and rewarded (i.e., Learning and Growth perspective).

The subject matter discussed in the Background section is not necessarily prior art and should not be assumed to be prior art merely as a result of its discussion in the Background section. Along these lines, any recognition of problems in the prior art discussed in Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

Embodiments illustrate and describe a goal management system. A large organization is permitted to define perspectives from which the organization will be viewed by its members. Team leaders, with cooperation of the members, form goals and objectives having specific measurable criteria that are in line with the perspectives and high level goals set out by the organizations executive team. As members of the organization work to accomplish the goals, points are awarded and accolades are given thereby motivating each team member to work faithfully toward the accomplishment of the objectives.

In accordance with some embodiments described herein, a non-transitory computer-readable storage medium includes stored contents that configure a computing system to perform a method. The method includes the acts of storing in at least one memory, a plurality of system-wide unique scorekeeper identifiers, receiving first input data representing at least one business goal of a plurality of business goals, each of the at least one business goals associated with one of the plurality of scorekeeper identifiers, receiving second input data representing a plurality of business objectives, each of the plurality of business objectives assigned to one of the plurality of scorekeeper identifiers, each of the plurality of business objectives linked to at least one of the plurality of business goals, and receiving third input data assigning one of a plurality of priorities to each of the plurality of business objectives. The method also includes the act of repeatedly receiving fourth input data assigning one of a plurality of stages of completion to each of the plurality of business objectives, calculating a maximum possible score for each of the plurality of objectives, the maximum possible score based on the assigned one of the plurality of priorities and a final one of the plurality of stages; and receiving fifth input data representing a forecasted score for each of the plurality of objectives, the forecasted score based on an expected stage of completion during a certain period of time over which the plurality of objectives will be measured. In response to each repeated receipt of fourth input data, the method calculates a current actual score for each of the plurality of objectives associated with the respective received fourth input data, the current actual score based on the assigned priority and the assigned one of the plurality of stages. The method also calculates, for each scorekeeper, a scorecard forecast score based on a combination of forecasted scores associated with the respective scorekeeper, and for each scorekeeper, a scorecard actual score based on a combination of current actual scores associated with the respective scorekeeper. Finally, the method generates output data representing the scorecard forecast score and the scorecard actual score for at least one scorekeeper.

In additional or alternative embodiments, the first input data and the second input data are represented as text. In additional or alternative embodiments, the method is arranged to operate within an intranet.

In some embodiments, the method also includes the act of normalizing, for each scorekeeper, the scorecard forecast score and the scorecard actual score.

In still other embodiments, the method defines a plurality of accolades, each accolade having a different value wherein higher value accolades are associated with greater achievement, and the method distributes accolades to at least some of the scorekeepers based on the scorecard actual score.

The goal management system embodiments described herein represent tangible, concrete ideas administered via one or more computing devices. Rather than using merely a computing device, the embodiments described herein and significantly more. Embodiments call out specific hardware components, such as a processing unit, an input/output interface, a transceiver, and other structures including one or more memory devices specifically programmed to solve complex problems. The embodiments of the goal management system described herein cannot be administered merely via the human mind, using a pencil and a pad of paper, for at least the reason that the embodiments are configured to serve a multitude of users in real time that cannot be served outside of the systems described herein.

The embodiments described herein are limited by the claims, which expressly recited particular elements and limitations. Thus, innovation around these types of goal management and gaming system technologies will be stimulated and not at all stifled.

Within the system, calculations are administered in real time.

The innovation described in the present disclosure is new and useful.

The innovation described herein use known building blocks combined in new and useful ways along with other structures and limitations to create something more than has heretofore been conventionally known.

The embodiments described herein improve upon known business management processes and techniques.

The computerized acts described in the embodiments herein are not purely conventional and are not well understood. Instead, the acts are new to the industry. Furthermore, the combination of acts as described in the present embodiments provides new information, motivation, and business results that are not already present when the acts are considered separately.

There is no prevailing, accepted definition for what constitutes an abstract idea.

The embodiments described herein use computerized technology to improve the technology of management. The gamification of business management techniques is not well known, routine, or conventional in the management industry.

These features with other objects and advantages which will become subsequently apparent reside in the details of construction and operation as more fully described hereafter and claimed, reference being had to the accompanying drawings forming a part hereof.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a block diagram of a first goal management system embodiment;

FIG. 2 illustrates various logic modules arranged within the goal management system embodiment of FIG. 1;

FIG. 3 is a first input/output interface screen embodiment associated with a competitive goal management system embodiment;

FIG. 4 is a second input/output interface screen embodiment associated with a competitive goal management tool embodiment;

FIG. 5 is a third input/output interface screen embodiment associated with a competitive goal management system embodiment;

FIG. 6 illustrates a goal management gaming system delivered as Software as a Service (SaaS) to various organizations; and

FIG. 7 is a block diagram of another goal management gaming system embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks have not been shown or described in detail to avoid unnecessarily obscuring descriptions of the embodiments.

An organization typically fulfills a core function. For example, the core function of a for-profit company is to make money. The core function of a non-profit entity is to sustainably provide goods and/or services to a targeted group. The core function of a school is to educate students; the core function of a government entity is to provide services to its constituents; and the core function of a military is to protect the lives and property of its citizens. The success of an organization is generally dependent on its ability to execute its day-to-day tasks better than any of its competitors while providing useful goods or services to those that it serves. As organizations get larger, the ability to execute the day-to-day tasks becomes more difficult. For this reason, all known successful organizations employ some form of leadership structure to direct the day-to-day tasks.

As previously described, some business management techniques are known, and these business management techniques help leaders guide their organizations. These known techniques are reasonably effective in many cases, but an innovative new business management technique has now been discovered. This new business management technique is described herein in the context of various competitive goal management systems including one or more gaming system embodiments.

The competitive goal management system embodiments described herein represent tangible, concrete ideas administered via one or more computing devices. Rather than using merely a computing device to administer known business management techniques however, the embodiments described herein add significantly more. The embodiments call out specific hardware components, such as a processing unit, an input/output interface, a transceiver, and other structures including one or more memory devices specifically programmed to solve complex problems.

The embodiments of the competitive goal management systems described herein cannot be administered merely via the human mind or by using a pencil and a pad of paper. Instead, the embodiments are configured to serve a multitude of users in real time that cannot be served in other ways. Accordingly, the competitive goal management systems described herein are suitable for large organizations. The large organizations that are contemplated include organizations having sizable campuses wherein all members do not work in or pass the same point every day, organizations having members that work in remote or otherwise disparate locations, organizations that have members who do not see each other on a regular basis, organizations that have an intranet to internally communicate information to members, and the like. In these cases, it is desirable for the organization to make information regarding its goals, objectives, performance, etc. available to its members on a real-time basis and without the members having to take extraordinary efforts to either transmit or receive the information.

In the context of the present disclosure, the goal management systems described herein include elements of competition fostered between one or more individuals, teams, groups, or other recognized inter- or intra-organization entities. The goal management systems are in some cases discussed in terms of games, gaming, competitions, contests, matches, rounds, tournaments, or the like. It is understood, however, that the goal management systems do not require games, prizes, awards, trophies, or any other accoutrements expressly associated with “gaming.” Instead, while such aspects of gaming are included in the embodiments discussed herein, the goal management systems, devices, tools, methods, and such described in the present disclosure may suitably be applied to other non-gaming embodiments.

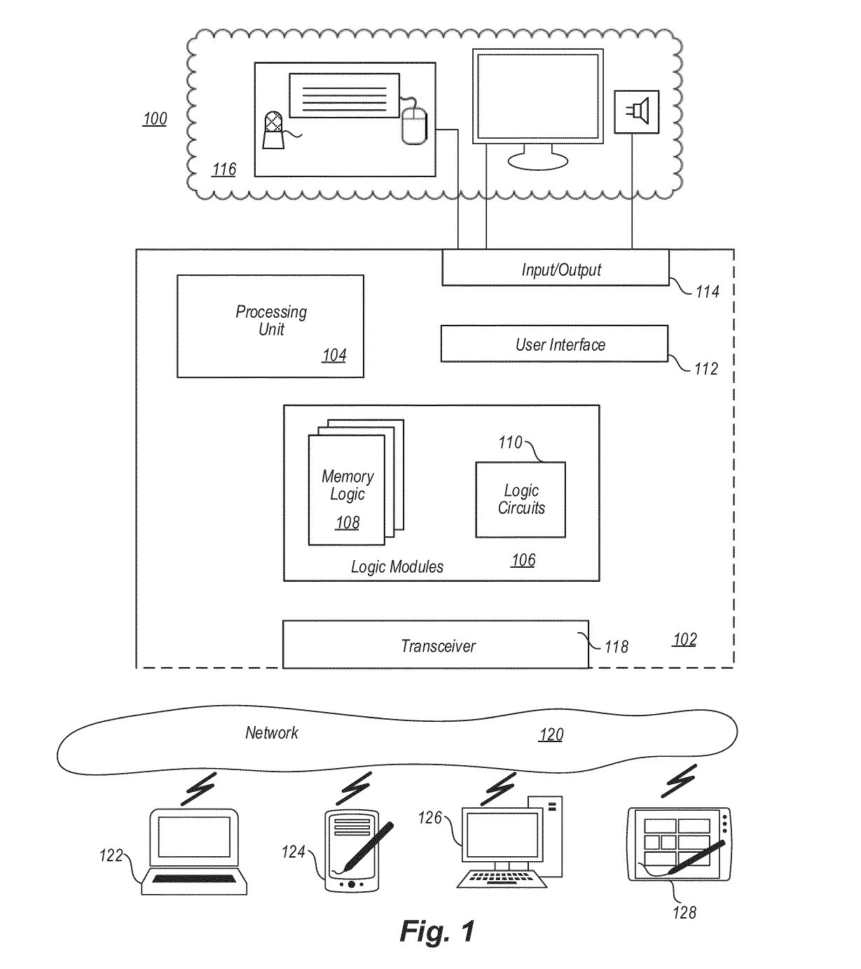

FIG. 1 is a block diagram of a goal management system embodiment 100 configured in a large organization. Within the large organization, individual members or teams of members compete against each other to advance the goals and objectives of the organization. In this way, all of the members of the organization stay motivated and on task, which helps the organization to fulfill its mission.

The goal management system may be set up as a competitive game or other environment wherein all members of the organization are participants. People compete as individuals or as members of a team, and the progress and results of each competitor are kept on a scorecard. When members compete is individuals, each of those individuals is a scorekeeper of their own scorecard; when members compete as a team, the team has a scorecard and one designated member acts as the scorekeeper for that scorecard. The scorecards in the goal management system are comprehensive and include a substantial number of individual datums linked together in various ways. Links may be formed amongst data from one scorecard and in addition, links may also be formed amongst data from two or more scorecards. Considering the volume of data contained in a scorecard, and the data links within scorecards and across scorecards, the system must be administered using one or more computing devices.

The purpose of the competition is to help all members of the organization form individual goals and objectives that are coordinated with goals and objectives of larger teams and of the organization itself at the highest level. Once the goals and objectives are formed, the competition helps the members of the organization stay motivated and focused on accomplishing the objectives in order to reach the goals. By using the competition, the organization can reach its higher potential in a more efficient way than any other management techniques offer.

The competition is carried out in a perpetual sequence of rounds, and at the completion of each round, winners are recognized and losers are identified. Often, each round of the competition is coordinated to cover a fiscal quarter of the organization, but this is optional. The organization can associate any time period that it finds useful with a round of the competition. Accordingly, each “time period” of the competition may also be referred to as a single round. In one example, an organization may choose quarters (i.e., three months) of the calendar year rather than the fiscal year. Alternatively, the organization may choose one month for each round of the competition, six months for each round of the competition, twelve months for each round of the competition, or some other number. Once the competition begins, data is captured throughout the period and scores are updated in real time; and at the end of the period results are recognized, and additional data is entered for the next.

At the beginning of each round, scorekeepers establish new objectives and new tangible measurements of key results for each objective. The scorekeepers link the objectives and the results to the goals and objectives of other teams and of the organization itself. This process permits the scorekeeper and the team members to think in advance of the work they will be doing in the upcoming time period. Objectives and key results are set with experience of previous rounds of the competition in mind, with objectives and key results of teams they will compete against in mind, and with the objectives and key results of the organization as a whole in mind. At the end of each time period, and at the beginning of each new time period, all of the members of an organization can look forward and work cooperatively with other members to advance the purpose of the organization.

Additional details of the goal management system 100 and other goal management embodiments are described herein with reference to the non-limiting embodiments illustrated in the figures and described in the text.

Turning back to FIG. 1, at the center of the goal management system embodiment 100, a computing device 102 operates. Computing device 102, which optionally includes various input/output devices 116 such as a keyboard, a mouse, a microphone, electronic display presentation devices, electronic audio output devices, and other input/output devices, may be any type of computing server or other device particularly configured to perform calculations on large volumes of data.

Computing device 102 may receive input data from one or more people or from one or more other computing devices. Computing device 102 may further receive input data from an internal or external database system (e.g., a SQL database) such as formed by logic modules 106, or computing device 102 may receive input data from other outside computing resources such as a laptop computer 122, a mobile device 124 (e.g., a smart phone), a conventional computer or computing server 126, a tablet computer 128, or some other computing system.

Although computing device 102 is illustrated as a single device, the solid lines and dotted lines that form the border of computing device 102 recognize that computing device 102 may include a single device, a plurality of devices, or an entire network of cooperating computing devices.

In the embodiment of FIG. 1, computing device 102 includes a transceiver 118 which cooperatively communicates through a network 122 with other computing devices.

As illustrated in FIG. 1, network 120 is an intranet, and network 120 is not the Internet. In this way, the information communicated between devices associated with the goal management system 100 is contained within the organization and not available to the public in an uncontrolled manner. Network 120 may include any suitable combination of a wide area network (WAN) such as the Internet, a local area network (LAN), a personal area network (PAN), or any other suitable network structure. Even when network 120 includes portions of the Internet, such communications are secured within a virtual private network (VPN), private peer-to-peer communications, encrypted communications, and the like.

Computing device 102 has operative electronic circuitry including a processing unit 104, multiple input/output (I/O) ports 114, memory logic 108 (e.g., volatile and non-volatile memory), logic circuitry 110 (e.g., universal serial bus (USB) circuits, cryptography circuits, etc.). Within the memory logic 108, several software programs are resident including an operating system, a database administration program, communication algorithms, and the goal management system logic, which in some cases is embodied as a management tool gaming environment.

The processing unit 104 of the computing device 102 retrieves and executes instructions from memory logic 108. An operating system includes application and driver software that permits additional application software and system administrators to control the operation of the computing device 102. For example, particular applications and drivers are used to accept data input and to provide system output through I/O ports 114. That is, keypads, computer mice, memory cards, serial ports, bio-sensor readers, touch screens, network interfaces, and the like are all useful to a programmer, system administrator, or other computing device operator to provide control information into the computing device 102. A user interface module 112 is associated with one or more presentation devices (e.g., displays), printers, memory cards, LED indicators, speakers, network interfaces, and the like to present output information to a computing device 102 operator.

In addition to application and driver software within the operating system, the operating system hosts a goal management system application, which includes computer instructions stored in memory logic 108. In one embodiment, the goal management system is capable of processing data and providing information related to the management of a large organization. The data may be processed and the information rendered for presentation on a local display, on a display coupled through network 120, or on another electronic or non-electronic medium (e.g., printed reports).

The goal management system may be implemented as a collection of one or more software programs capable of communicating with other computing devices. For example, conventional transmission control protocol/Internet protocol (TCP/IP), file transfer protocol (FTP), user datagram protocol (UDP), and the like are useful to permit data such as web pages, database function calls, scripts, and other electronic data to be served to outside computing resources, and further are useful to permit users of the outside computing resources to input data into the computing device 102. These protocols and outside computing resources, however, are nevertheless contained within the organization via the use of an intranet.

In some embodiments, the goal management system is stored as one or more files on computer-readable media (CRM). The CRM is non-transitory, and configured to store computing instructions executable by a CPU. Each file may include one or more computer programs or may be part of a larger computer program. Alternatively or in addition, each file may include data or other computational support material for the goal management system. Embodiments of the goal management system typically execute a set of instructions stored on computer-readable media.

In other embodiments, the goal management system exists as an entire computing system having a processing unit 104, logic modules 106, a user interface 112, a transceiver 118, and an input/output port 114 configured in hardware and software as several modules. The modules of the goal management system embodiment may include hardware (e.g., a CPU, memory, I/O ports, etc.), software, or computing devices having both hardware and software configured to carry out the operations of the module. In some cases, the modules share hardware and software, and in other cases, the modules use dedicated hardware, dedicated software, or some combination.

The goal management system 100 embodiment of FIG. 1 provides a framework under which a large organization can define and achieve a desired set of goals and objectives. The framework engages members of the organization at all levels. The executive management team in the organization sets goals for the organization. Using the executive goals as a starting point, other members of the organization use the goal management system 100 embodiment to create their own sets of goals and objectives in line with the executive goals. The system then promotes objectives relevant to the executive goals, and rallies teams around achieving successful objective scores. The goal management system 100 embodiment combines effective practices from several management methodologies with the psychological principles of competition thereby permitting the organization to bridge the gap between strategy and execution.

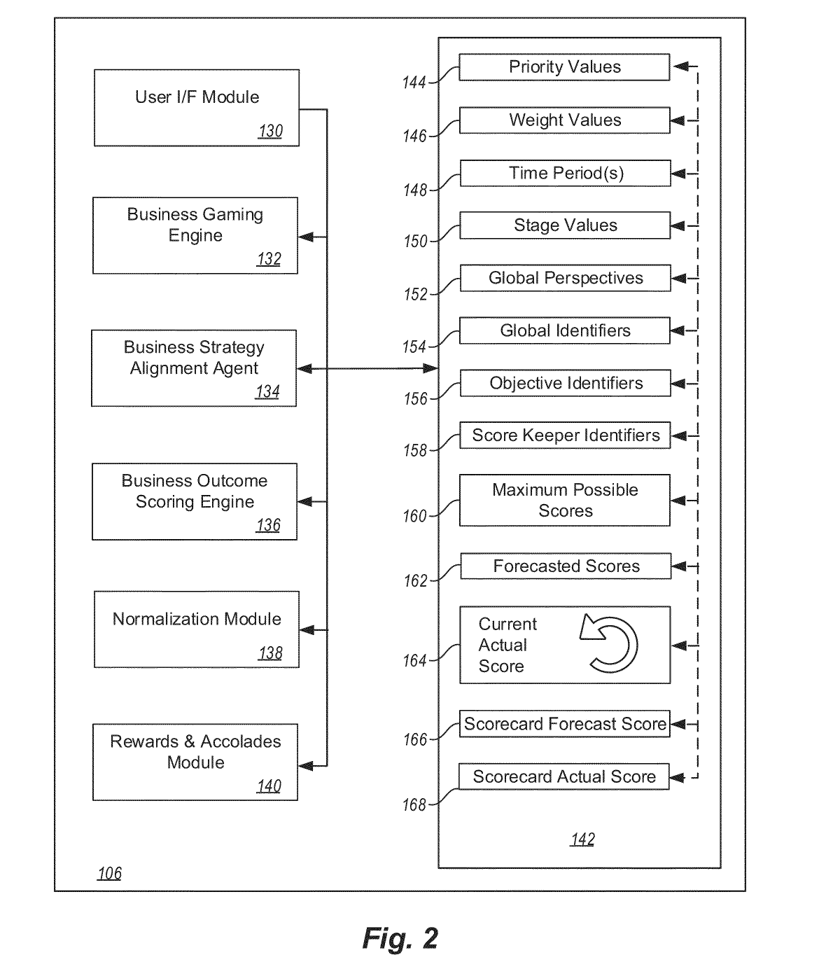

FIG. 2 illustrates various logic modules 106 arranged within the goal management system 100 embodiment of FIG. 1. The logic modules 106 include a variety of executable modules including a user interface module 130, a business competition (e.g., gaming) module 132, a business strategy alignment engine 134, a business outcome scoring engine 136, a normalization module 138, and a rewards and accolades module 140. These particular executable modules 130-140 are arranged to carry out particular procedures, methods, and acts of the goal management system 100 embodiment of FIG. 1. The executable modules 130-140 are communicatively coupled to each other and also communicatively coupled to a database structure 142.

The database structure 142 of FIG. 2 defines a multitude of repositories 144-168. Certain ones of the repositories may include any number of links to other ones of the repositories as described herein. The repositories 144-168 may receive data and supply data to the executable modules 130-140. Illustrated within the database structure 142 are a priority values repository 144, a weight values repository 146, a time period repository 148, a stage values repository 150, a global perspectives repository 152, a global identifiers repository 154, and objective identifiers repository 156, a scorekeeper identifiers repository 158, a maximum possible scores repository 160, a forecasted scores repository 162, a current actual score repository 164 a scorecard forecast score 166, and a scorecard actual score 168. Some of the repositories 144-168 of database structure 142 are configured to hold a single value; other ones of the repositories 144-168 are configured to hold a plurality of values. Some of the repositories 144-168 of database structure 142 are configured to be initialized and not changed while the goal management system 100 embodiment is operating; other ones of the repositories 144-168 of database structure 142 are infrequently updated such as during each new period, and still others of the repositories 144-168 of database structure 142 are frequently updated in real time whenever other information is updated, such as when the executable business competition (e.g., gaming) engine 132 or business outcome scoring engine 136 produces new data.

The goal management system 100 embodiment applies elements of game playing (e.g., point scoring, rules of play, competition) to other areas of activity to encourage participation. For every defined period, which may be three months, six months, a year, or some other time period, team members create a goal-oriented roadmap (e.g., blueprint, chart, game plan, or the like), keep score to encourage healthy competition, and receive rewards and accolades for their performance. All the while, the organization is benefiting from team members working enthusiastically and diligently toward the executive goals of the organization. At the conclusion of one period, teams review their successes, assess their misses, design their roadmap for the next period, and then begin working again on their objectives for the new period. This rapid cycle of setup, perform, and review allows the team members to remain motivated, flexible, and agile to meet an organization's shifting priorities. Using the goal management system 100 embodiment, organizations align team objectives with overall strategy, motivate players to strive for success, and deliver on planned outcomes. When the goal management system is arranged as a game, for example, players are expressly and inherently motivated to play to win.

The goal management system 100 embodiment of FIG. 1 is arranged to include features of a balanced scorecard, which are modified for use within the system. The balanced scorecard is used in the system to align the business activities of a large organization to the vision and strategy of the organization. The use of balanced scorecards in the system improves communications throughout the organization and monitors the performance of teams and individual members within the context of the organization's strategic goals.

In the embodiment now described, four global perspectives of the large organization are defined and tracked. For the sake of brevity, the four perspectives include a Financial perspective, a Customer perspective, an Internal Process Improvement perspective, and a Learning and Growth perspective, which have been used in the conventional balanced scorecard (BSC) management technique. In other embodiments, however, different organizations can define different perspectives, more perspectives, or fewer perspectives. That is, the goal management system 100 of FIG. 1 is flexible and permits an organization to enter and customize any number of particular perspectives. The customized perspectives provide the large organization with a mechanism to balance its own chosen set of goals and objectives within view of its own chosen perspectives.

After an organization defines and enters its perspectives into the goal management system 100, the organization can define and enter organizational goals. Each of the organizational goals is associated to one or more of the previously entered perspectives.

For example, with respect to a Financial perspective, one organizational goal may be to increase revenue by bringing a particular new product or service to market. The goal is not bound to a particular time line or time period, but instead the goal keeps the organization focused toward continued and future growth of the organization. In addition, the goal may also be tied to other perspectives, and the goal may also be tied to other goals. For example, the organizational goal of bringing a particular new product or service to market may also be associated with the Learning in Growth perspective. The organizational goal of bringing a particular new product or service to market may further be associated with another goal such as providing certain employees with particular skills training.

The goal management system 100 embodiment allows an organization to enter any number of goals limited only by the particular resources of the system (e.g., amount of memory). Generally speaking, one or two goals for each defined perspective of the organization is preferred, but other numbers are permitted.

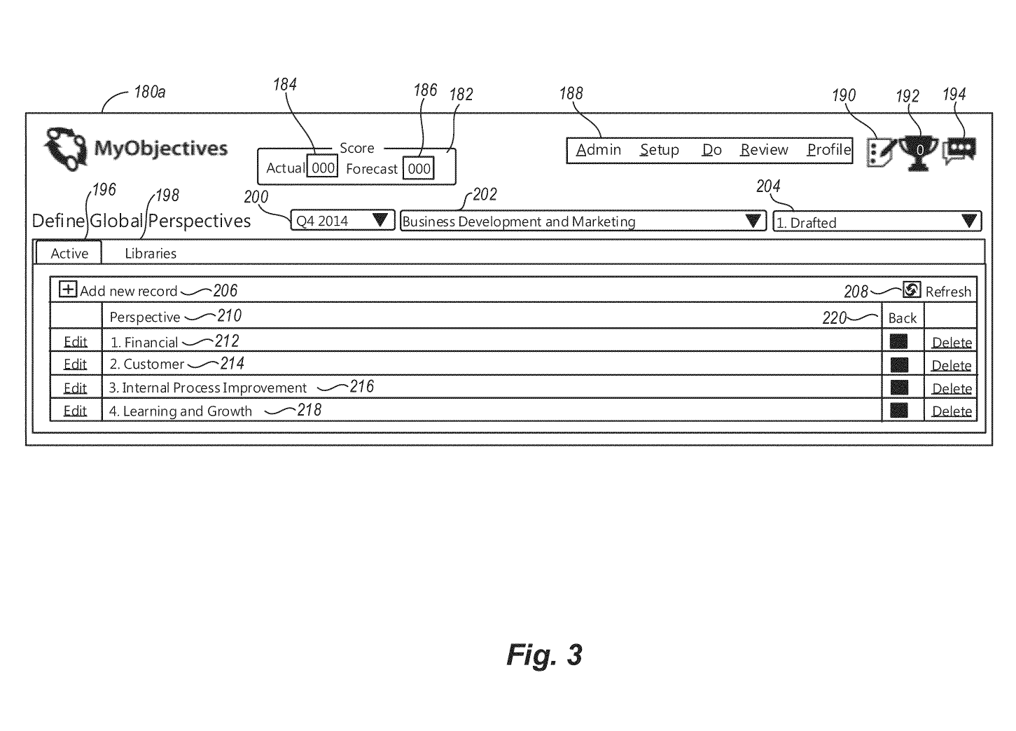

FIG. 3 is a first input/output interface screen 180a embodiment associated with a competitive goal management system embodiment such as the goal management system embodiment illustrated in FIG. 1. The interface screen 180a represents one view of a scorecard. The embodiment is rendered via user interface 112 (FIG. 1) and with the assistance of hardware and software logic modules 106. The first input/output interface screen 180a provides one of many portals useful for entering information and receiving status updates regarding scorecards embodied in the competitive goal management system.

One set of features represented in the first input/output interface screen 180a includes a scoreboard feature 182. The scoreboard feature 182 presents a scorecard actual score 184 and a scorecard forecast score 186. In some cases the scoreboard presents data for an individual scorekeeper or team; in other cases the scoreboard presents data for a plurality of individual scorekeepers or teams; in still other cases, the scoreboard presents data for an entire organization. For example, within the competitive goal management system, each individual scorekeeper can enter goals, objectives, and other data for themselves or for a team they are responsible for. In these cases, the individual scorekeeper will desirably see a scoreboard representing their own scores or the scores of their team. In other cases, for example when the large organization has several divisions, one of the division leaders may wish to see the scoreboard representing a composite of all of the teams in his or her division. At other times, the division leader may wish to see a score for a single team, or a composite score for the entire organization. In this way, the scoreboard is flexibly configurable to view scores from individuals, some or all teams, or the entire organization.

Another feature represented in the first input/output interface screen 180a is a configurable toolbar 188. In the embodiment of FIG. 3, the toolbar is illustrated having five menu choices: Admin, Set up, Do, Review, Profile. In other embodiments, the toolbar may have the same or different choices. When a user selects one of the menu choices on a configurable toolbar 188, the user is presented with additional interfaces that allow the user to configure the competitive goal management system embodiment. For brevity, these additional interfaces are not described in detail.

The first input/output interface screen 180a may also include status information and command information. A notes icon 190, for example, may indicate that information entered by a particular team member is available to read. In this way different team members can use the competitive goal management system to communicate with each other. An accolades icon 192 can indicate particular achievements or awards won by the team during the competition. The accolades are awarded for adapting best practices and achieving success thresholds, or for other reasons. The accolades awarded can be during a current time period or cumulative over two or more periods. An alerts icon 194 may be used to indicate that a user needs to take action within one particular aspect of the competition or another.

The scorecard illustration of the first input/output interface screen 180a in FIG. 3 is shown having a tabbed view. A first competition status tab 196 indicates a scorecard view of “Active” perspectives for a particular scorekeeper. In the embodiment of FIG. 3, a scorekeeper identifier 202 shows the “Business Development and Marketing” team as the particular scorekeeper associated with the illustrated scorecard. Internally within the competitive system, the scorekeeper is the designated owner of a scorecard. Within the organization, the scorekeeper is often a team lead, unit lead, or department lead specifically defined within the reporting structure of the organization, however, this is not a fixed requirement because the competitive goal management system configurably allows users to choose any scorekeeper they prefer.

A new record command 206 can be accessed, which permits a user to enter new data into the scorecard and thereby into the competitive goal management system. A global perspectives identifier 210 represents that this particular large organization has defined four global perspectives, which can be accessed with a Financial perspectives identifier 212, a Customer perspectives identifier 214, an Internal Process Improvement perspectives identifier 216, and a Learning and Growth perspectives identifier 218. As indicated in FIG. 3, a user is permitted to edit any of the information associated with the perspectives or add new perspectives. Naturally, permissions to make such changes may be controlled with a security administration policy not described here.

Perspectives in the competitive goal management system embodiment constitute an improvement over a conventional balanced scorecard methodology. The four perspectives illustrated in FIG. 3 (i.e., Financial, Customer, Internal Process Improvement, and Learning and Growth) represent a methodology to view this particular large organization and to develop metrics, collect data, and analyze the data relative to each of these perspectives. It is recognized however that the leadership team of any other organization may choose different perspectives which are important to their own organization. The chosen perspectives of the organization, however allow each of the members of the organization to balance goals and objectives in line with the chosen perspectives. The competitive goal management system improves on the previous balance scorecard methodology by visibly and perpetually carrying the perspectives through to all of the other actions of the organization's members. That is, due to the implementation of the competitive goal management system described herein, all or nearly all views of scorecards carry express indications or reminder cues back to the global perspectives set out by the leadership team.

It is also noted that each of the perspectives may be associated with a particular color as shown in FIG. 3 beneath a breadcrumbs back command 220. The particular color coding is user configurable and persists across many different views of the scorecard providing visual indicator cues to different team members of how and where particular objectives are associated with the organizations high level perspectives. The breadcrumbs back command 220 may be used to navigate through previous pages or views of the scorecard.

As shown in FIG. 3, a drop-down list is provided for the scorecard view of a particular time period 200. The time period may be communicated in many ways, however in this particular embodiment the drop-down list was preferred. In this way, a user can select a scorecard view of any current or previous time period for the competitive goal management system. Along these lines, another drop-down list and bodies a scorekeeper identifier 202. Other techniques may of course be used to identify a scorekeeper who scorecards will be viewed or compared, but in the present embodiment the drop-down list was preferred. If the user selects the scorekeeper identifier 202, the user is able to choose any of the scorekeepers that have been defined within the competition. In the present embodiment, the Business Development and Marketing team is identified, but other teams may include a Production team, a Service team, an Accounting team, an Executive team, a Research and Development team, and so on.

A current stage identifier 204 represents a current stage of progress on the scorecard associated with the chosen scorekeeper, which is the Business Development and Marketing team in the present embodiment. The current stage identifier 204 may be used in different ways. For example, the current stage identifier 204 in this case may be selectable by a user to show particular objectives of the chosen scorekeeper that are at the “Drafted” stage. Alternatively, the current stage identifier 204 may be a status indicator of how much progress has been made on a current objective. In another alternative, the current stage identifier 204 may be an entry point whereby the scorekeeper sets the current stage status of the associated objective.

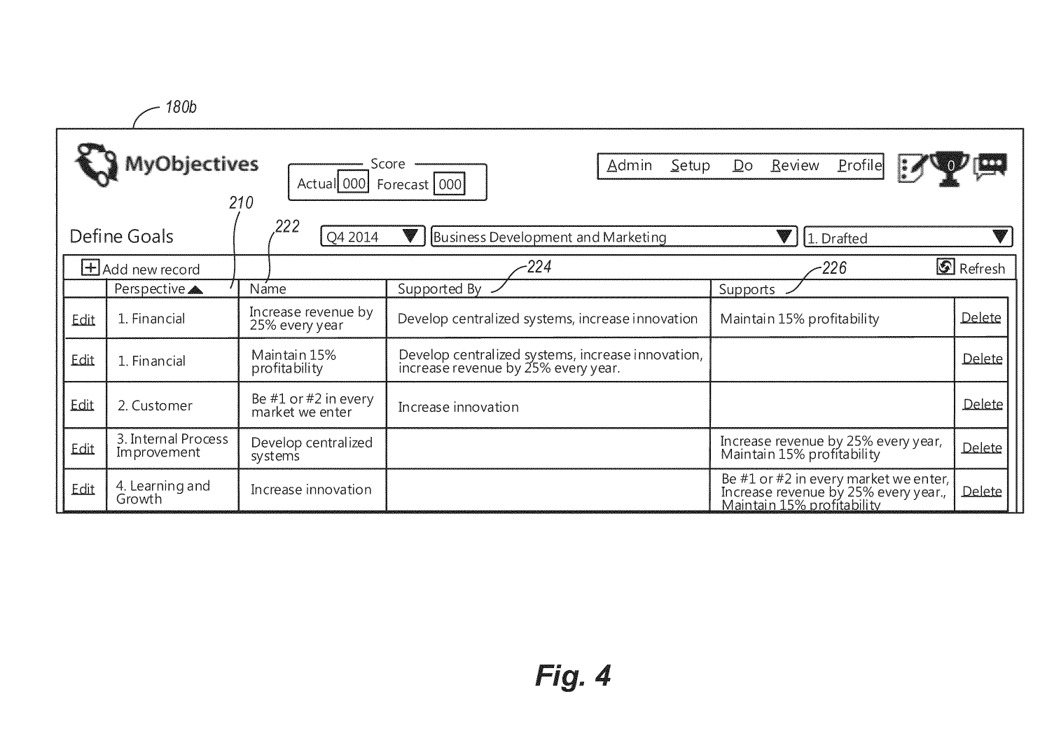

FIG. 4 is a second input/output interface screen 180b embodiment associated with a competitive goal management system embodiment. As in FIG. 3, the interface screen 180b represents another view of the scorecard associated with the Business Development and Marketing team scorekeeper identifier. The embodiment in FIG. 4 is similar to the embodiment in FIG. 3 in other ways too. For example, the embodiment of FIG. 4 is rendered via user interface 112 (FIG. 1) and with the assistance of hardware and software logic modules 106, and the second input/output interface screen 180b provides another one of many portals useful for entering information and receiving status updates regarding scorecards embodied in the competitive goal management system. Where they are the same, reference indicators from FIG. 3 are not repeated in FIG. 4 for simplicity.

Similar to the global perspectives identifier 210, and the associated perspectives identifiers 212-218 of FIG. 3, a scorecard owner can enter goals. Goals are not bound by timelines, but instead goals keep the organization focused on long-term direction. As illustrated in FIG. 4, the organization's perspectives have been defined, and the Business Development and Marketing team has entered, or is entering, a set of goals. Although the goals persist across one or more time periods, the goals entered in the second input/output interface screen 180b embodiment help guide activities for the current or upcoming round of the competition, which is shown in FIG. 4 as Q4 2014.

The global perspectives identifier 210 column shows that the team has entered two goals expressly in line with the Financial perspective and one goal expressly in line with each of the Customer, Internal Process Improvement, and Learning and Growth perspectives, respectively.

Three additional columns not illustrated in FIG. 3. are now presented in the second input/output interface screen 180b embodiment of FIG. 4. The additional columns include a name identifier 222, a supported-by identifier 224, and a support-for identifier 226. Other mechanisms to identify and name particular objectives and goals are clearly contemplated. Nevertheless, the implementation shown in FIG. 4 was chosen for this particular embodiment.

The name identifier 222 column allows a user to enter a particular description for each goal.

A first goal in FIG. 4 is named, “Increase revenue by 25% every year.”

A second goal is named, “Maintain 15% profitability.”

A third goal is named, “Be #1 or #2 in every market we enter.”

A fourth goal is named, “Develop centralized systems.”

The fifth goal is named, “Increase innovation.”

Along with each goal, the scorecard permits identification of other goals that support the current goal, or are supported by the current goal. For example, looking at a first row in the scorecard of FIG. 4, the first goal named “Increase revenue by 25% every year” is supported by the fourth goal (“Develop centralized systems”) and the fifth goal (“Increase innovation”); and the first goal supports the second goal (“Maintain 15% profitability”). Using the second input/output interface screen 180b view of the scoreboard, a scorekeeper can define goals for his associated team members. The goals are associated with the organizations global perspectives, and each of the goals is cross-linked with other goals. While FIG. 4 illustrates support-for and support-by other goals of this same particular scorekeeper, this is not a limitation. With the competitive goal management system contemplated herein, the goals of one team can support goals of other teams or be supported by goals of other teams, and this feature can readily be made apparent in real time across the scorecards of all team members. In this way, on an ongoing basis, team members will perpetually know where the work they are doing fits into other work being performed within the organization. This ever-present, high-visibility feature is innovative and not implementable in previous systems.

After a scorekeeper has defined individual or team goals, the scorekeeper will define measurable objectives for a current or upcoming round of the competition. Measurable objectives are created for a given team and organized by category for a specific time period. Although the competition does not require collaboration by team members for the creation of objectives, the competitive nature encourages active participation by all members of the team in the definition of objectives and the measurable criteria that are established to determine the success or failure of the team during the round.

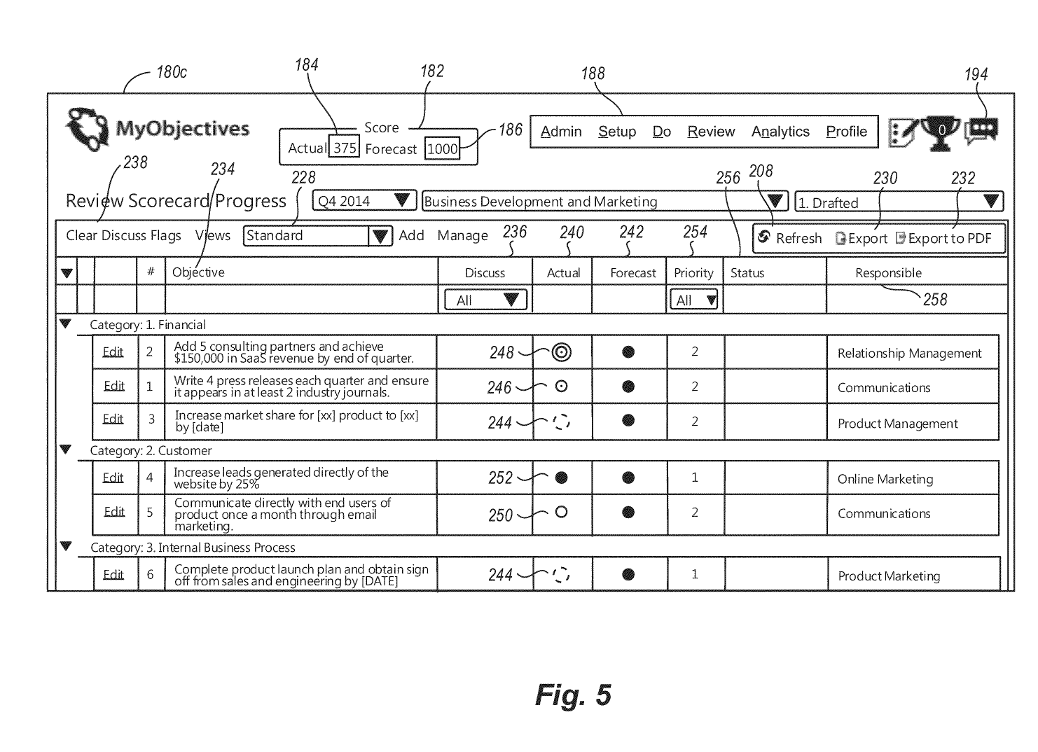

FIG. 5 is a third input/output interface screen 180c embodiment associated with the competitive goal management system embodiment now discussed. As in FIGS. 3 and 4, the interface screen 180c represents another view of the scorecard associated with the Business Development and Marketing team scorekeeper identifier. The embodiment in FIG. 5 is similar to the embodiments in FIGS. 3 and 4. For example, the embodiment of FIG. 5 is rendered via user interface 112 (FIG. 1) and with the assistance of hardware and software logic modules 106, and the third input/output interface screen 180c provides another one of many portals useful for entering information and receiving status updates regarding scorecards embodied in the competitive goal management system. In FIG. 5, certain reference indicators illustrated in earlier figures are not repeated in FIG. 5 for simplicity.

Two notable differences between the scorecard illustration in FIG. 5 and the scorecards illustrated in other figures are pointed out. The first difference is associated with the scoreboard feature 182, which is shown in FIG. 5 along with the scoreboard actual score 184 and the scoreboard forecast score 186. In the embodiment of FIG. 5, non-zero values are evident in the scoreboard actual score 184 and the scoreboard forecast score 186. The non-zero values indicate that the competition is currently underway. In this particular round, the Business Development and Marketing team has forecast and achievable score of 1000 for the Q4 2014 time period. The team has also been working on its objectives, and has a current actual score of 375.

A second difference in FIG. 5 is associated with the configurable toolbar 188. In the scorecard embodiment of FIG. 5, the configurable toolbar 188 has been configured to now include a selectable Analytics menu item. If a user selects the Analytics menu item, the competitive goal management system permits the user to review a wide range of analytics associated with different aspects of the present scorecard and other scorecards.

The third input/output interface screen 180c embodiment provides a portal through which a scorekeeper can create objectives. The objectives will guide short and long term tasks for the team during an upcoming round of the competition. In addition, the third input/output interface screen 180c embodiment also provides a portal through which the scorekeeper can enter progress updates during the current round (i.e., time period) of the competition. The third input/output interface screen 180c embodiment also provides a portal through which all team members can receive real-time status associated with any particular team in the organization. As will be apparent to one of skill in the art, the particular format of the third input/output interface screen 180c can be adjusted or modified with the inclusion or exclusion of optional data in many ways.

An objectives identifier 234 is identified in FIG. 5. It is apparent in the figure that the objectives identifier 234 is a column heading for a plurality of individual objectives entered into the system. Within the competitive goal management system, every objective entered into the system receives its own system-wide unique identifier value, which is linked to other information associated with the objective.

Within FIG. 5, a first objective includes the text, “Write 4 press releases each quarter and ensure it appears in at least 2 industry journals.” This objective includes a “1” in a “#” column. This objective is the first objective associated with the Business Development and Marketing team in Q4 2014. Also evident in FIG. 5, this first objective is associated with the Financial perspective.

A second objective includes the text, “Add 5 consulting partners and achieve $150,000 in SaaS revenue by end of quarter.” Like the first objective, this second objective is associated with the Financial perspective.

A third objective, also associated with the Financial perspective, includes the text, “Increase market share for (xx) product to (xx) by (date).

A fourth objective includes the text, “Increase leads generated directly off the website by 25%.” The fourth perspective is associated with the Customer perspective.

A fifth objective, associated with the Customer perspective, includes the text, “Communicate directly with end-users of product once a month through email marketing.”

A sixth objective is associated with the Internal Business Process perspective and includes the text, “Complete product launch plan and obtain sign off from sales and engineering by (DATE).”

FIG. 5 includes a column entitled ‘Discuss,’ 236, which permits a scorekeeper or configurable and other members of the organization to include points of discussion associated with the objective. The discuss identifier 236 also includes an associated clear-discuss-flags identifier 238. One option within the third input/output interface screen 180c associates discussion points entered with the alerts icon 194 and the clear-discuss-flags command. In this way members of the organization can signal other members of the organization that discussion points associated with a particular objective have been entered, read, adjusted, or otherwise manipulated.

The third input/output interface screen 180c includes two associated columns represented in FIG. 5, an actual score identifier 240 and a forecast score identifier 242. Within the columns, “dots” having representative colors and structural formation indicate to all members in real-time a status of the particular objective.

In FIG. 5, a red dot 244 indicates a starting or planning stage. At this stage, and objective has been agreed on by team members, drafted, and entered into the competitive goal management system, but no appreciable work toward accomplishing the objective has been accomplished.

A yellow circle 246 indicates a progress stage.

A yellow dot 248 indicates a partial success stage.

A green circle 250 indicates that progress on the objective is bordering success.

A green dot 252 indicates that the work toward the objective has successfully been completed.

Three additional identifiers represented in the third input/output interface screen 180c of FIG. 5 include an assigned priority identifier 254, a status identifier 256, and a responsible party identifier 258. Information associated with each objective can be entered into the competitive goal management system. These three identifiers are shown in FIG. 5 as column headings. It is understood, however, that each of these identifiers represents a system-wide unique identifier associated with one particular objective.

The first objective in FIG. 5 is assigned a priority of “2,” no status has yet been entered, and the Communications department or assigned Communications team member is responsible for the objective. The responsibility can be determined within the organization, but in many cases, the individual is tasked with ensuring that work toward accomplishing the objective is started, done well, and completed. Along these lines, it is evident that no status has yet been entered for any objectives, but the second and fifth objectives are also assigned a priority of “2,” the third objective is assigned a priority of “3,” and the fourth and sixth objectives are assigned a priority of “1.” Further along these lines, the Communications team member is responsible for the fifth objective, the Relationship Management team member is responsible for the second objective, the Product Management team member is responsible for the third and sixth objectives, and the Online Marketing team member is responsible for the fourth objective.

The competitive goal management system described herein improves upon known management techniques. This new competitive goal management system incorporates aspects of the Management by Objectives technique, the Objective Management technique, S.M.A.R.T. Objectives techniques, and Objectives and Key Results techniques. The incorporation of these improvements with a balanced scorecard and competitive environment between individual organization members and teams allows an organization to relate high-level strategies and goals to specific team objectives. That is, the competitive goal management system embodiments described herein focus on creating a relationship between organizational goals and team objectives. There is a relationship between objectives and a scorecard. Each scorecard incorporates multiple objectives. There is also a relationship between each objective and a specific organizational goal. Each objective that is set by an individual member or a team is related to one or more of the organizations goals. Thus each team can, in real time, show which objectives contribute to the accomplishment of which organizational goals along with a path of accomplishment for each objective.

SMART is a mnemonic acronym used within the competitive goal management system. SMART provides criteria that guide a scorekeeper in the definition of their objectives. Additional input/output interface screens are used to tie each written objective to criteria that is “S,” specific, “M,” measurable, “A,” achievable, “R,” relevant, and “T,” timely. That is, with respect to each one of the plurality of objectives that are entered into an embodiment such as goal management system 100, the system allows the scorekeeper to enter specific, measurable, achievable, relevant, and timely attributes of the respective objective, which are stored in memory, and linked to the objective. When any members of the organization review scorecards, they have the ability to access these specific attributes to understand how the team member or team is working to advance the organizations goals.

RACI is another mnemonic acronym used within the competitive goal management system, wherein each letter of the acronym identifies an important responsibility associated with each objective entered by a scorekeeper. Each objective includes data identifying: a party that is “R,” responsible, a party that is “A,” accountable, parties who are “C,” consulted, and parties who are “I,” informed. In some cases, the RACI data is stored in a matrix, which may be known as a responsibility assignment matrix (RAM), a RACI matrix, or a linear responsibility chart (LCR). The group of RACI data stored in the memory is linked expressly to a particular objective and directly or indirectly to other objectives, other members of the organization, teams of the organization, goals of the organization, or other particular data.

RACI data describes the participation of various members or teams to complete tasks or provide deliverables associated with a particular project or process of the organization. The RACI data is useful to clarify roles and responsibilities in cross-functional/departmental projects and processes. Looking specifically at the criteria defined within a competitive goal management system embodiment, data associated with “R,” responsible parties identify individual organization members who work to achieve the objective or work to complete tasks associated with the objective. Often one member of the organization is assigned to be responsible for each objective though others can be delegated to assist.

Within the system, it is understood that members of an organization may be assigned system-wide unique identifiers, and the mechanism employed to assign a responsible party involves storing identifiers in particular defined data locations. The express mechanism to store certain numerical values and assign organizational meaning to particular data locations can be carried out many ways and is not discussed here for simplicity.

Data associated with “A,” accountable parties typically identify one organization member ultimately accountable for the correct and thorough completion of the deliverable subject matter or task. Each organization can define how an accountable party is defined or used, but in many cases, the accountable party is the one to whom the “R,” responsible party is accountable. In other words and accountable party must sign off (e.g., approve) work that a responsible party provides. Generally, there is only one accountable party specified for each task or provider of deliverable subject matter.

Data associated with “C,” consulted parties typically identifies organization members or external parties whose opinions are sought. Communication with these parties is typically bi-directional. Optionally, the communication is captured within the competitive goal management system.

Data associated with “I,” informed parties typically identifies organization members were kept up-to-date on progress. In some cases status information or discussion information is communicated to or between informed parties while work is being performed. In other cases, the information is communicated only when a task or deliverable subject matter is completed or when a task moves to a new stage, or a success stage. Optionally, communication with an informed party may be one directional; that is, out bound to the informed party.

In some embodiments, yet one more aspect of competitive goal management methodologies is available. This aspect, i.e., gamification, is incorporated in some the competitive goal management system embodiments described herein. Gamification, when it is employed, provides a way to motivate teams using terminology, atmosphere, accolades, prizes, and other such features that are not typically associated with a “work” environment. The gaming, distributed accolades, and other features are built into the competitive goal management system to provide motivation expressly tied to an organization's priorities while also providing an employee or other organization member with an outlook that is associated with recreational, fun, or other desirable pursuits. For these employees or other organization members, playing the game provides a favorable reason to go to work and to work hard supporting the priorities of the organization while at work.

Accolades are provided in a variety of forms. Non-limiting examples of accolades include Status Stages and Icons, Actual and Forecasted Scores, Team Badges, and Financial Rewards and Gifts. Using accolades, the competitive goal management system embodiments described herein rewards teams for success, and success is determined based on real-time information provided through scorecards.

When a round of the competition begins, all of the different teams begin working on tasks to accomplish their objectives. As the work progresses through the round (i.e., through the time period), points are accumulated by the teams. An organization can define particular score success zones, which are ranges of accumulated points in which the accomplishment of the objective is determined to be a success. The organization can also configure an objective priority balance which allows a normalization of scoring across scorecards. Another term for such scoring success zones and objective priority balance is “tuning.”

Within the competitive goal management system, tuning takes into account two particular pieces of information collected with respect to each objective: 1) progress stages, and 2) prioritization of objectives.

Progress stages track the progress completion of an associated objective. In the embodiment described herein there are six progress stages available, which are identified in Table 1. In other embodiments a different number of stages and different criteria to pass through different stages may be configured.

TABLE 1
Stages of an Objective

| Stage | Definition |
|---|---|
| Planning | No activity has begun. |
| Started | The objective is in play and efforts to meet key |
| | results are underway. |
| Progress | Some progress, for example 25%, has been reached. |
| Partial Success | More than 50% of the key results have been achieved. |
| Bordering | Virtually all of the key results have been realized, |
| Success | though some work remains. |
| Success | The key results have been achieved as determined by the |
| | individual scorekeeper or team. |

The competitive goal management system allows an organization to track objectives, and the progress through stages of an objective, both qualitatively and quantitatively. In a qualitative approach, teams track the progress of an objective using the stages described in Table 1. Teams work together to understand progress of the objective based on the measurable aspects of completion determined when the objective was defined and entered into the competitive goal management system. In a quantitative approach, the progress toward a goal can be tracked from an external system. With respect to the goal management system 100 embodiment of FIG. 1, data may be received through the input/output system 114 or the transceiver 118 which is configured to accept such data. For example, if a particular number of sales, or web views of an Internet web page are incorporated into an objective, then various thresholds toward the successful completion of the objective can be set by the scorekeeper. As the time period progresses and sales or webpage views accumulate, certain thresholds can be automatically fed into the competitive goal management system, and progress will accumulate in real time on the team's scorecard. Actual numbers may be programmatically entered or other types of data such as percentages, coded values, and the like.

Another aspect of tuning includes the prioritization of objectives. In the embodiment described herein four priorities are defined with a configurable fifth priority that recognizes uncertainties that arise in many organizations. With respect to the fifth priority, team members are cautioned to exercise awareness that accepting unplanned objectives may impact the team's ability to compete since accepting such unplanned objectives consume team resources and divert attention from other objectives already defined. The team is permitted to take on unplanned objectives, but the scorecard provides visibility into other objectives that may suffer. Table 2 identifies these five named priority values; however, other embodiments may define a different number of priorities and assign different criteria associated with said priorities.

TABLE 2
Prioritization

| Priority Value | Definition |
|---|---|
| Priority 1 | Critical - Must be Completed. |
| Priority 2 | Essential - Needs to be Completed. |
| Priority 3 | Important - Should be Completed. |
| Priority 4 | Stretch - Attempt to Complete. |
| Unplanned | This setting is used for objectives that are added after the |
| | scorecard setup process is complete. |

Within the competitive goal management system, a priority stage score describes a cumulative score assigned to each objective based on a combination of priority and stage. Formula 1 provides one mechanism for calculating a priority stage score although other mechanisms are available.

PSS=PSMP*SWP (1)
Wherein,
PSS=Priority Stage Score,
PSMP=Priority Success Maximum Points, and
SWP=Stage Weight Percentage.

As described herein, an objective, when it is defined, is assigned a particular priority with respect to the importance of the objective in cooperation with the higher-level goals of the organization. Thus, the Priority Success Maximum Points represents a highest number of points and objective can receive based on its assigned priority. A Stage Weight Percentage describes how much of the PSMP is awarded to the objective at each progress stage.

Once a Priority Stage Score is calculated, the score can be used to assign possible, actual, and forecast scores for each objective in the system. These scores are represented in a scorecard, for example, the scoreboard actual score 184 and the scoreboard forecast score 186. An objective possible score, as another example, represents possible points for a given objective after it has achieved the “success” stage. It is possible for an objective possible score of one objective to be higher or lower than the objective possible score of another objective, and this happens when the two objectives have different priorities.

An objective forecast score represents forecasted points for a given objective calculated at a stage the team expects to reach during a given round of competition. This ability for a team to set its own objective forecast score is another feature not found in conventional management techniques. It is recognized within the competitive goal management system that not every objective can or should reach a “success” stage during a given round. Some of objectives are much longer in duration than a single time period. Using this mechanism, scorecard scores can nevertheless be normalized and objectively compared in pursuit of competition. An objective actual score represents actual points for a given objective at any given time during a round of competition. The actual points are illustrated in real-time. The objective actual score is formed using the priority and the current stage of completion of the objective.

After the possible, forecast, and actual scores of each objective are determined, the values can be aggregated for each scorecard within the competitive goal management system. Aggregated and normalized scores for each objective are then applied and presented via the scorecard. As each round of competition progresses, the scorecard scores can be leveraged by the organization to motivate teams across the organization to make progress on their own objectives.

Two non-limiting scorecard score formulas are provided. The formulae are used in some embodiments of the competitive goal management system, however in other embodiments, different formulae are used.

SFC=Sum(OFS/NumObj/100)*1000 (2)
Wherein,
SFC=Scorecard Forecast Score,
OFS=objective forecast scores per scorecard, and
NumObj=number of objectives.

SAS=Sum(OAS/NumObj/100)*1000 (3)
Wherein,
SAS=Scorecard Actual Score,
OAS=objective actual scores per scorecard, and
NumObj=number of objectives.

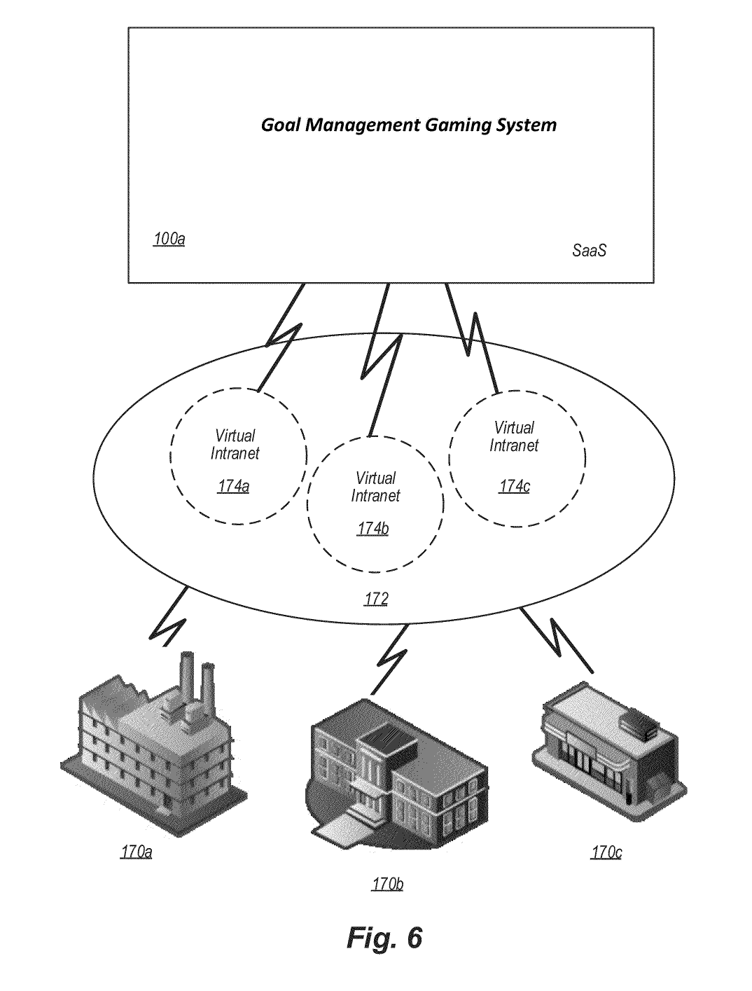

FIG. 6 illustrates a goal management gaming system 100a embodiment delivered as Software as a Service (SaaS) to various organizations. The goal management gaming system 100a includes features substantially as described with respect to the goal management system 100 and FIGS. 1-5. The goal management gaming system 100a administers competitive games for several organizations including a factory organization 170a, a school organization 170b, and a retail goods and services (e.g, store) organization 170c. Communications with each organization may occur across a network 172, which may be the Internet. Even though communications may be transferred across a public network such as the Internet, the communications are nevertheless private. That is, aspects of scorecards, objectives, organizational goals, and the like are not publicly available. One mechanism to keep such communications private is shown in FIG. 6 wherein communications to the illustrated organizations pass through a virtual intranet 174a, 174b, 174c, respectively.

A non-limiting embodiment of the goal management gaming system 100a is now described as implemented across virtual intranet 174a in the context of FIGS. 1-6. In the embodiment, the goal management gaming system 100a provides a computer implemented goal management gaming tool using a processing unit 104, logic modules 106, a user interface 112, an input/output interface 114, and a transceiver 118. The processing unit executes computing instructions on data. The computing instructions, which are stored in the memory logic 108, are arranged to store and retrieve data from at least one memory, receive user-input and generate user-output that is passed through the input/output interface 114, and by-directionally communicate data to one or more remote computing devices 122-128 via a computing network 120. The data passing through the user interface module 112 may be textually and graphically arranged for presentation such as the data illustrated in scorecard embodiments of FIGS. 3-5.

The memory logic 108 may include local or remote memory configured with particular data structures, some of which may be formed in a database. The data structures and database may include repositories as in FIG. 2. Values stored in the repositories include definitions of four or more priority values, weight values for six or more stages, and a time period. A time period represents the duration of one round of a game, although information for many rounds of the game can of course be stored. System-wide unique identifiers may be stored for each member of the organization, and members that are scorekeepers in the gaming system may also have assigned scorekeeper identifiers. When values are system-wide unique, each particular one of those values can be used to distinguish itself from other values of the same type.

Also stored in the memory logic are a plurality of system-wide unique goal identifiers and a plurality of system-wide unique objective identifiers. Each goal identifier represents an organizational goal, which in this case is a business goal important to the factory organization 170a. Each objective identifier represents a business objective of the factory organization 170a. Naturally, the number of business objective identifiers will be the same or higher than the number of goal identifiers since within the game, each high level goal of the organization will have one or more associated objectives. With further respect to the objectives, the factory organization 174a may require every objective in the system include specific S.M.A.R.T. criteria. That is, for each objective, the member may be required to enter specific attributes of the respective objective, measurable attributes of the respective objective, achievable results of the respective objective, relevant attributes of the respective objective, and timely attributes of the respective objective. In addition, or in the alternative, the factory organization 174a may require every objective in the system include specific RACI criteria. I.e., an identifier representing a first person responsible for the respective objective, an identifier representing a second person accountable for the respective objective, one or more identifiers representing at least one third person respectively who can be consulted regarding the respective objective, and an identifier representing a fourth person to be informed about the respective objective.

The game is established in the factory organization 174a such that each scorekeeper is linked with at least one objective and typically several, and each objective is linked with one or more goals. One of the plurality of priorities is assigned to each objective, and at the beginning of around each of the plurality of objectives is initialized to one of the plurality of stages. The objective need not be initialized to the very first defined stage, however, because as has been described, the completion of an objective may span several time periods.

As member data, scorekeeper data, and objective data, is entered into the goal management gaming system 100a embodiment, a variety of initial values can be calculated. In some cases, the values are calculated after all data is entered, however, and other cases, the initial values are calculated continuously and displayed with up-to-the-moment accuracy on a scorecard. One piece of initial data calculated includes maximum possible scores for each of the plurality of objectives. The maximum possible scores are based on the assigned priority and a final one of the plurality of stages. Forecasted scores for each of the plurality of objectives can also be assigned based on an expected stage of completion during the period of time over which the particular objective will be measured. Since both management and subordinate members of the factory organization 170a are working cooperatively to develop objectives and their associated parameters, the forecasted scores tend to be reachable if the team challenges itself.

Before a round of the game begins, and continuously while the game is being played, a current actual score for each of the plurality of objectives will be calculated. The current actual scores based on the priority assigned to the objective and a determined “current stage” of accomplishment for the objective.

User input may come into goal management gaming system 100a through the user interface 112. During a round of the game, the user input may represent at least one updated stage assigned to a corresponding one of the objectives. As new data is received (i.e., as a stage of an objective is updated), the current actual score may be recalculated for each of the plurality of objectives associated with the user input.

The goal management gaming system 100a calculates, for each scorekeeper, a scorecard forecast score based on a combination of forecasted scores associated with the sub-plurality of the plurality of objective identifiers linked to the respective scorekeeper. The system also calculates, for each scorekeeper, scorecard actual score based on a combination of current actual scores associated with the at least one of the plurality of objective identifiers linked to the respective scorekeeper. In some cases, one or both of the scorecard forecast score and the scorecard actual score are normalized. The normalization includes weighting the particular scores such that scores from one scorecard are fairly compared to scores of another scorecard. The normalization process allows the competitors in the game to be motivated merely by comparing a numerical score of their scorecard to that of another team's scorecard. Another motivating factor within the game may include the definition of success zones. The success zones include a lower boundary and an upper boundary around a particular scorecard actual score. The zone of success between the boundaries represents an area where the factory organization 170a has determined are sufficient to advance the organization's goals. Advancing a score on the scorecard into the success song is motivating because team members recognize that entry into the zone may be sufficient to tie or even beat other competitors' scores.

With or without success zones, the factory organization 170a may decide that certain accolades would further enhance the motivation of its members. In this respect, a plurality of accolades may be defined whereby each accolade has a different value. Typically, higher value accolades are associated with greater achievement, but other structures are envisioned too. The accolades may represent status icons, team badges, financial rewards, and other nonfinancial gifts such as permission to park in a particular stall, permission to bring a pet into the factory, etc. Scorecard forecast score and the scorecard actual score can be output on any one of the scorecard embodiments, for example, the embodiments shown in FIGS. 3-5.

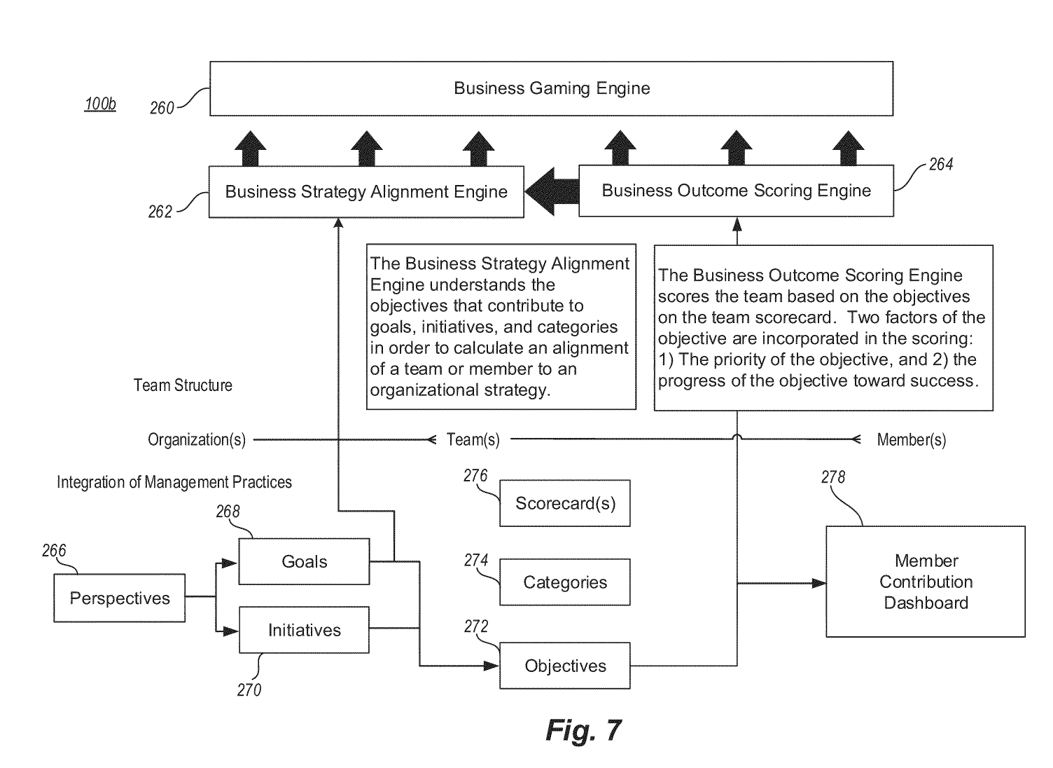

FIG. 7 is a block diagram of another goal management gaming system embodiment 100b. The embodiment of FIG. 7 also illustrates a flow chart representing a progression of data through the goal management gaming system. Prominently evident in FIG. 7 are a business gaming engine module 260, a business strategy alignment engine module 262, and a business outcome scoring engine module 264. As represented in the figure, the business strategy alignment engine 262 understands the objectives that contribute to goals, initiatives, and categories in order to calculate an alignment of a team or member to an organizational strategy. The business outcome scoring engine 264 scores the team based on the objectives on the team scorecard. Two factors of the objective are incorporated into the scoring including 1) The priority of the objective, and 2) The progress of the objective toward success.

Stated differently the business strategy alignment engine 262 allows an organization to track its business goals. Organizations can then ask teams to track the link between objectives they set and the business goals. The Association of objectives to goals describes the objectives that when accomplished are contributing to the accomplishment of the overarching goal of the entire organization. The more objectives and organization or team accomplishes that are related to a goal, the more aligned the organization is to that given goal.

Turning back to FIG. 7, the executive team within the organization determines a set of perspectives 266 which will be used to provide a different ways for members of the organization to view the organization. The view from those different perspectives allows members to create goals 268 and initiatives 270.

In the middle of FIG. 7, a hierarchical connection is drawn is drawn between an Organization(s) to various Team(s) of the organization, which are made up of individual Member(s). The Organization-Team-Member connection spans across all of the individual structures of the goal management gaming system 100b. As represented in FIG. 7, the perspectives 266, goals 268, and initiatives 270 are set by an executive team at the organization-level. Information from the perspective's 266 flows through both the goals 268 and the initiatives 270.

Data from the goals 268 is used within the business strategy alignment engine 262. The data from the goals 268 and the initiatives 270 also filters down into the objectives 272. Data from the objectives 272 filters into a categorical repository 274 and also a plurality of scorecards 276. The objectives, categories, and scorecards fall under the responsibility of the teams.

As the objectives 272 are defined (within the context of the categories 274 and scorecards 276), the data passes into the business outcome scoring engine 264. Data also is represented in real time through the member contribution dashboard 278. Within the data flow of FIG. 7, objective data passes through the business outcome scoring engine 264 for processing in a business gaming engine 260. Data from the business outcome scoring engine 264 is also processed with respect to the business strategy alignment engine 262, which also passes data through the business gaming engine 260.

A non-limiting embodiment with respect to FIGS. 1-7 is now described with respect to the school organization 170b (FIG. 6). The school organization 170b may include an entire district of schools in a large metropolitan area. In this case, the district may include dozens and dozens of individual schools, thousands of teachers and administrators, and an even larger staff of maintenance personnel, purchasing personnel, education specialists, volunteers, and so on. In order to administer a best practices management structure across such a large disparate organization, a new and innovative system such as illustrated in FIG. 7 and described herein is necessary.

The computing system of the goal management gaming system 100b naturally includes a processing unit 104, a memory 106, and an input/output port 114 configured in hardware and software as several modules. A business strategy alignment engine 262 stores a plurality of system-wide unique scorekeeper identifiers. From the executive level of the organization, the business strategy alignment engine receives business goal input data representing at least one business goal but preferably including a plurality of business goals. Each of the received business goals is associated with one of the scorekeepers. Business objective input data from a plurality of business objectives is also received, and each of the received business objectives is assigned to one of the scorekeepers. Each of the received business objectives is also linked by the business strategy alignment engine 262 to at least one of the business goals. Finally, the business strategy alignment engine receives prioritization data assigning one of a plurality of priorities to each of the received plurality of business objectives. The business strategy alignment engine 262 receives this data through its cooperative work with both the business gaming engine 260 and the business outcome scoring engine 264.

The business outcome scoring engine 264 is configured to receive and act on data particularly related to the objectives and the accomplishments of the team members related to the objectives. The business outcome scoring engine 264 calculates maximum possible scores for each of the plurality of objectives, wherein the maximum possible score is based on the assigned priority and a final possible stage of achievement of the objective. Forecasted score input data representing a forecasted score for each of the plurality of objectives is received by the business outcome scoring engine 264. The forecasted score is based on an expected stage of completion during a certain period of time (i.e., a round of the game) over which the plurality of objectives will be measured.

The business outcome scoring engine then performs calculations associated with each particular scorekeeper. For example, a scorecard forecast score based on a combination of forecasted scores is calculated, and a scorecard actual score based on a combination of current actual scores is calculated. Finally, the business outcome scoring engine 264 generates output data representing the scorecard forecast score and the scorecard actual score for each scorekeeper depending on which devices accessing which scorecard embodiment, the scorecard data for any particular scorekeeper is updated and viewed in real time. In this way, all of the members of the entire school organization 170b can participate in each round of the game in ways that are heretofore unavailable with any other system.

The business gaming engine module 260 interactively cooperates with the business strategy alignment engine 262 and the business outcome scoring engine 264. The business gaming engine 260 repeatedly receives stage-completion input data assigning one of a plurality of the defined stages of completion to each of the plurality of business objectives. In response to each repeated receipt of stage-completion input data, the business gaming engine 260 re-calculates the current actual scores for each of the plurality of scorekeepers.

The business gaming engine 260 may further perform calculations to normalize scorecard data and administer a plurality of accolades, which can be very motivating to the members of the school organization 170b.

Unless the context requires otherwise, throughout the specification and claims, the word “comprise” and variations thereof, such as, “comprises” and “comprising” are to be construed in an open, inclusive sense; that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary subject based communication facilitation server computing system generally described above.

For instance, the foregoing detailed description has set forth various embodiments of the devices, modules, and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

As used herein, the term “module” refers to an electronic circuit, a processor (e.g., shared, dedicated, group, single core, multicore, or the like) and memory operative to execute one or more software or firmware programs, an application specific integrated circuit (ASIC), a combinational logic circuit, or some other individual or cooperative coupling of suitable components (either hardware or software) that provides the functionally described with respect to the module.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as hard disk drives, flash drives, CD ROMs, digital tape, and computer memory; and transmission type media such as digital and analog communication links using TDM or IP based communication links (e.g., packet links).

The various embodiments described above can be combined to provide further embodiments. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer implemented goal management method, comprising:
providing a processing unit that executes computing instructions on data, the data including first data and second data, the computing instructions arranged to:
store the first data in at least one memory,
retrieve the second data from the at least one memory,
receive user-input constituting at least some of the first and second data,
generate user-output from at least some of the first and second data, and
bi-directionally communicate at least some of the data between one or more remote computing devices, the one or more remote computing devices communicatively coupled together via a computing network;
providing a user interface module, the user interface module configured to textually and graphically arrange for presentation an output portion of the data stored in the at least one memory, the user interface further configured to accept a user input portion of the data;
defining a priority value for each of a plurality of priorities, there being at least four priorities;
defining a weight value for each of a plurality of stages, there being at least six stages;
storing in the at least one memory, a value representing a period of time over which a plurality of objectives will be measured;
storing in the at least one memory, a plurality of scorekeeper identifiers, each scorekeeper identifier representing one scorekeeper, each scorekeeper identifier being distinguishable from other scorekeeper identifiers within the computer implemented goal management method;
storing in the at least one memory, a plurality of goal identifiers, each goal identifier representing a business goal, each goal identifier being distinguishable from other goal identifiers within the computer implemented goal management method;
storing in the at least one memory a plurality of objective identifiers, each objective identifier representing one business objective of the plurality of objectives, each objective identifier being distinguishable from other objective identifiers within the computer implemented goal management method, the number of objective identifiers in the plurality of objective identifiers being greater than or equal to the number of goal identifiers in the plurality of goal identifiers;
linking, in the at least one memory, each scorekeeper with at least one objective identifier of the plurality of objective identifiers;
linking, in the at least one memory, each objective identifier with at least one goal identifier;
assigning one of the plurality of priorities to each of the plurality of objectives;
initializing each of the plurality of objectives to a first one of the plurality of stages;
calculating a maximum possible score for each of the plurality of objectives, the maximum possible score based on the assigned priority and a final one of the plurality of stages;
assigning a forecasted score for each of the plurality of objectives, the forecasted score based on an expected stage of completion during the period of time over which the plurality of objectives will be measured;
calculating a current actual score for each of the plurality of objectives, the current actual score based on the assigned priority and a determined current stage of the plurality of stages;
accepting user input via the user interface, the user input representing at least one updated stage assigned to a corresponding one of the plurality of objectives;
re-calculating the current actual score for each of the plurality of objectives associated with the user input representing the at least one updated stage;
calculating, for each scorekeeper, a scorecard forecast score based on a combination of forecasted scores associated with the at least one objective identifier of the plurality of objective identifiers linked to the respective scorekeeper;
calculating, for each scorekeeper, a scorecard actual score based on a combination of current actual scores associated with the at least one objective identifier of the plurality of objective identifiers linked to the respective scorekeeper; and
generating output data representing the scorecard forecast score and the scorecard actual score for at least one scorekeeper.

2. The computer implemented goal management method according to claim 1, comprising:
with respect to each one of the plurality of objectives, permitting entry in the at least one memory of at least five criteria of the objective, the five criteria including specific attributes of the respective objective, measurable attributes of the respective objective, achievable results of the respective objective, relevant attributes of the respective objective, and timely attributes of the respective objective.

3. The computer implemented goal management method according to claim 1, comprising:
with respect to each one of the plurality of objectives, permitting entry in the at least one memory of at least four criteria of the objective, the four criteria including an identifier representing a first person responsible for the respective objective, an identifier representing a second person accountable for the respective objective, one or more identifiers representing at least one third person respectively who can be consulted regarding the respective objective, and an identifier representing a fourth person to be informed about the respective objective.

4. The computer implemented goal management method according to claim 1 wherein the one or more remote computing devices include at least one of a smartphone, a mobile device, a tablet computer, a laptop computer, a desktop computer, and a computing server.

5. The computer implemented goal management method according to claim 1 wherein the computing network is an intranet.

6. The computer implemented goal management method according to claim 1 wherein the computing network is not the Internet.

7. The computer implemented goal management method according to claim 1 wherein the first memory is configured as a database.

8. The computer implemented goal management method according to claim 1, comprising:
normalizing, for each scorekeeper, the scorecard forecast score and the scorecard actual score.

9. The computer implemented goal management method according to claim 1, comprising:
defining a plurality of accolades, each accolade having a different value wherein higher value accolades are associated with greater achievement, the accolades representing at least one of a status icon, a team badge, a financial reward, and a non-financial gift.

10. The computer implemented goal management method according to claim 9, comprising:
defining a success zone, the success zone having a lower boundary and an upper boundary; and
distributing certain ones of the plurality of accolades when a scorecard actual score is within the success zone.

11. A non-transitory computer-readable storage medium whose stored contents configure a computing system to perform a method, the method comprising:
storing in at least one memory, a plurality of system-wide unique scorekeeper identifiers;
receiving first input data representing at least one business goal of a plurality of business goals, each of the at least one business goals associated with one of the plurality of scorekeeper identifiers;
receiving second input data representing a plurality of business objectives, each of the plurality of business objectives assigned to one of the plurality of scorekeeper identifiers, each of the plurality of business objectives linked to at least one of the plurality of business goals;
receiving third input data assigning one of a plurality of priorities to each of the plurality of business objectives;
repeatedly receiving fourth input data assigning one of a plurality of stages of completion to each of the plurality of business objectives;
calculating a maximum possible score for each of the plurality of objectives, the maximum possible score based on the assigned one of the plurality of priorities and a final one of the plurality of stages;
receiving fifth input data representing a forecasted score for each of the plurality of objectives, the forecasted score based on an expected stage of completion during a certain period of time over which the plurality of objectives will be measured;
in response to each repeated receipt of fourth input data, calculating a current actual score for each of the plurality of objectives associated with the respective received fourth input data, the current actual score based on the assigned priority and the assigned one of the plurality of stages;
calculating, for each scorekeeper, a scorecard forecast score based on a combination of forecasted scores associated with the respective scorekeeper;
calculating, for each scorekeeper, a scorecard actual score based on a combination of current actual scores associated with the respective scorekeeper; and
generating output data representing the scorecard forecast score and the scorecard actual score for at least one scorekeeper.

12. The non-transitory computer-readable storage medium according to claim 11 whose stored contents configure a computing system to perform a method, wherein the first input data and the second input data are represented as text.

13. The non-transitory computer-readable storage medium according to claim 11 whose stored contents configure a computing system to perform a method, wherein the method is arranged to operate within an intranet.

14. The non-transitory computer-readable storage medium according to claim 11 whose stored contents configure a computing system to perform a method, comprising:
normalizing, for each scorekeeper, the scorecard forecast score and the scorecard actual score.

15. The non-transitory computer-readable storage medium according to claim 11 whose stored contents configure a computing system to perform a method, comprising:
defining a plurality of accolades, each accolade having a different value wherein higher value accolades are associated with greater achievement; and
distributing accolades to at least some of the scorekeepers based on the scorecard actual score.

16. A computing system, comprising:
a processing unit, a memory, and an input/output port configured in hardware and software as several modules, said modules including:
a business strategy alignment engine module configured to:
store a plurality of system-wide unique scorekeeper identifiers;
receive business goal input data representing at least one business goal of a plurality of business goals;
associate each of the received business goals with one of the plurality of scorekeeper identifiers;
receive business objective input data representing a plurality of business objectives;
assign each of the received business objectives to one of the plurality of scorekeeper identifiers;
link each of the received business objectives to at least one of the plurality of business goals; and
receive prioritization input data assigning one of a plurality of priorities to each of the received plurality of business objectives;
a business outcome scoring engine module configured to:
calculate a maximum possible score for each of the plurality of objectives, the maximum possible score based on the assigned one of the plurality of priorities and a final one of the plurality of stages;
receive forecasted score input data representing a forecasted score for each of the plurality of objectives, the forecasted score based on an expected stage of completion during a certain period of time over which the plurality of objectives will be measured;
calculate, for each scorekeeper, a scorecard forecast score based on a combination of forecasted scores associated with the respective scorekeeper;
calculate, for each scorekeeper, a scorecard actual score based on a combination of current actual scores associated with the respective scorekeeper;
generate output data representing the scorecard forecast score and the scorecard actual score for at least one scorekeeper; and
a business gaming engine module configured to:
repeatedly receive stage-completion input data assigning one of a plurality of stages of completion to each of the plurality of business objectives;
in response to each repeated receipt of stage-completion input data, re-calculate the current actual score for each of the plurality of scorekeepers.

17. The computing system according to claim 16 wherein the memory is organized as a database.

18. The computing system according to claim 16, further comprising:
a normalization module configured to normalize, for each scorekeeper, the scorecard forecast score and the scorecard actual score.

19. The computing system according to claim 16, wherein the business outcome scoring engine module is configured to:
define a plurality of accolades, each accolade having a different value wherein higher value accolades are associated with greater achievement; and
distributing accolades to at least some of the scorekeepers based on the scorecard actual score.

20. The computing system according to claim 19, wherein the business outcome scoring engine module is configured to:
define a success zone, the success zone having a lower boundary and an upper boundary; and
distribute certain ones of the plurality of accolades when a scorecard actual score is within the success zone.
